(19) United States
(12) Patent Application Publication
(10) Pub. No.: US 2022/0337488 A1
(43) Pub. Date: Oct. 20, 2022

(54) NETWORK DEVICE TYPE CLASSIFICATION

(71) Applicant: Avast Software s.r.o., Prague (CZ)

(72) Inventors: Michal Najman, Vsetin (CZ); Dmitry Kuznetsov, Prague (CZ)

(73) Assignee: Avast Software s.r.o., Prague (CZ)

(21) Appl. No.: 17/231,802

(22) Filed: Apr. 15, 2021

(51) Int. Cl. H04L 12/24; G06N 5/02; G06N 20/00; G06N 5/04; H04L 29/06

(52) U.S. Cl. CPC H04L 41/16; G06N 5/02; G06N 20/00; G06N 5/04; H04L 63/0209

(57) ABSTRACT

A method of identifying network devices includes transforming a first data set of feature-rich device characteristics of devices with known device identities to a second data set comprising feature-poor device characteristics with the known device identities. A third data set of feature-poor device characteristics of devices with known identities is collected. A statistical model is derived comprising one or more adjustments to the transformed data set, the statistical model reflecting a difference in statistical distribution between one or more characteristics of the second data set of transformed device characteristics and one or more corresponding and/or related characteristics of the third data set of feature-poor device characteristics. A device identification module is trained based on the second data set of feature-poor characteristics and the statistical model adjustments, the trained device identification module operable to use feature-poor device characteristics to identify network devices.

### FIELD

The invention relates generally to computer networks, and more specifically to networked device identification and classification.

### BACKGROUND

Computers are valuable tools in large part for their ability to communicate with other computer systems and retrieve information over computer networks. Networks typically comprise an interconnected group of computers, linked by wire, fiber optic, radio, or other data transmission means, to provide the computers with the ability to transfer information from computer to computer. The Internet is perhaps the best-known computer network, and enables millions of people to access millions of other computers such as by viewing web pages, sending e-mail, or by performing other computer-to-computer communication.

But, because the size of the Internet is so large and Internet users are so diverse in their interests, it is not uncommon for malicious users or pranksters to attempt to communicate with other users' computers in a manner that poses a danger to the other users. For example, a hacker may attempt to log in to a corporate computer to steal, delete, or change information. Computer viruses or Trojan horse programs may be distributed to other computers or unknowingly downloaded such as through email, download links, or smartphone apps. Further, computer users within an organization such as a corporation may on occasion attempt to perform unauthorized network communications, such as running file sharing programs or transmitting corporate secrets from within the corporation's network to the Internet.

For these and other reasons, many computer systems employ a variety of safeguards designed to protect computer systems against certain threats. Firewalls are designed to restrict the types of communication that can occur over a network, antivirus programs are designed to prevent malicious code from being loaded or executed on a computer system, and malware detection programs are designed to detect remailers, keystroke loggers, and other software that is designed to perform undesired operations such as stealing information from a computer or using the computer for unintended purposes. Similarly, private network security appliances can monitor network activity on a private network, protecting a wide variety of devices on the network including devices such as Internet of Things devices that aren't capable of having third-party security software installed or that lack the resources to perform effective security functions.

For example, Avast's Omni security appliance uses a technique known as ARP spoofing to insert itself between private network devices and the private network's router, enabling it to monitor and selectively filter traffic between private network devices and a public network connected to the router. But, because routers and private network devices aren't designed to have traffic between them intercepted by a third party device, successful setup and configuration can sometimes be dependent on the type of router and other devices on the private network.

It is therefore desirable to identify or classify devices on a private network, such as to determine their suitability for use with services such as a private network security appliance.

### SUMMARY

One example embodiment of the invention comprises identifying network devices by transforming a first data set of feature-rich device characteristics of devices with known device identities to a second data set comprising feature-poor device characteristics with the known device identities. A third data set of feature-poor device characteristics of devices with known identities is collected. A statistical model is derived comprising one or more adjustments to the transformed data set, the statistical model reflecting a difference in statistical distribution between one or more characteristics of the second data set of transformed device characteristics and one or more corresponding and/or related characteristics of the third data set of feature-poor device characteristics. A device identification module is trained based on the second data set of feature-poor characteristics and the statistical model adjustments, the trained device identification module operable when trained to use feature-poor device characteristics to identify network devices.

In a further example, the trained module is deployed to one or more feature-poor network environments, such as a network security device, firewall, or router to identify network devices, such as to aid a malware protection module in protecting local network devices.

In another example, the same transformed feature set can also be used to train a model usable in a feature-rich environment, without the adjustments or weights. Such a system provides for training models for both feature-rich and feature-poor environments from the same transformed or reduced feature-poor data set and known or confirmed device identities, reducing the workload on developers in generating models for different platforms as new devices are developed and found in local network environments.

The details of one or more examples of the invention are set forth in the accompanying drawings and the description below. Other features and advantages will be apparent from the description and drawings, and from the claims.

### BRIEF DESCRIPTION OF THE FIGURES

FIG. 1 shows a computerized network security device including a network device identification module, consistent with an example embodiment.

FIG. 2 shows a more detailed example of a network device employing a network device identification module, consistent with an example embodiment.

FIG. 3 is a block diagram of a network device identification system, consistent with an example embodiment.

FIG. 4 is a flowchart of a method of identifying a network device, consistent with an example embodiment.

FIG. 5 is a computerized system comprising a network device identification module, consistent with an example embodiment.

### DETAILED DESCRIPTION

In the following detailed description of example embodiments, reference is made to specific example embodiments by way of drawings and illustrations. These examples are described in sufficient detail to enable those skilled in the art to practice what is described, and serve to illustrate how elements of these examples may be applied to various purposes or embodiments. Other embodiments exist, and logical, mechanical, electrical, and other changes may be made.

Features or limitations of various embodiments described herein, however important to the example embodiments in which they are incorporated, do not limit other embodiments, and any reference to the elements, operation, and application of the examples serve only to define these example embodiments. Features or elements shown in various examples described herein can be combined in ways other than shown in the examples, and any such combination is explicitly contemplated to be within the scope of the examples presented here. The following detailed description does not, therefore, limit the scope of what is claimed.

As networked computers and computerized devices such as smart phones become more ingrained into our daily lives, the value of the information they store, the data such as passwords and financial accounts they capture, and even their computing power becomes a tempting target for criminals. Hackers regularly attempt to log in to a corporate computer to steal, delete, or change information, or to encrypt the information and hold it for ransom via “ransomware.” Smartphone apps, Microsoft Word documents containing macros, Java applets, and other such common documents are all frequently infected with malware of various types, and users rely on tools such as antivirus software or other malware protection tools to protect their computerized devices from harm. Malicious users often attempt to steal user credentials to popular online websites or services by creating fake sites pretending to be the popular websites, directing users to the fake sites by prompting them with emails alerting them to fictitious problems with their account that can be fixed by logging on or providing other such valuable information.

In a typical home computer or corporate environment, firewalls inspect and restrict the types of communication that can occur over a network, antivirus programs prevent known malicious code from being loaded or executed on a computer system, and malware detection programs detect known malicious code such as remailers, keystroke loggers, and other software that is designed to perform undesired operations such as stealing information from a computer or using the computer for unintended purposes. Web browser features or extensions similarly block unwanted content such as scripts, advertisements, popups, tracking cookies, known malicious downloads or websites, and other such undesirable web content. Network security appliances insert themselves between a router or gateway and private network devices such as computers, smartphones, and appliances on the private network, monitoring and selectively filtering network traffic between the private network devices and the router or gateway.

In a more detailed example, a network security device such as Avast's Omni uses ARP spoofing to appear to client devices on the private network to be the router, and to appear to the router to be the private network devices. Network traffic between the router and the private network devices is therefore routed through the security device, which can inspect the traffic for known or potentially malicious content and selectively block or filter such content from being forwarded to the private network devices. But, because some routers and other network devices work better with such techniques than others, identifying the router and other networked devices on the private network may help determine whether the devices will support the network security device, or require a certain configuration to work best.

Still other devices such as a personal computer on a private network may not have access to all the network traffic information as a network security appliance, but will make use of a more limited set of data or criteria to identify network devices for their own device-based malware management. Such criteria can include ports open on the device, traffic received from the device, and the like. But, because such devices work with a less feature-rich set of information than a network security appliance, they typically use their own data sets and cannot take advantage of information obtained by more sophisticated systems such as network security appliances that use more feature-rich data sets.

Some examples described herein therefore seek to identify network devices such as a router, computer, smart phone, or home appliance by sharing data sets between feature-rich and feature-poor environments. This is performed by collecting a first feature-rich data set of feature-rich device characteristics of devices with known device identities, such as characteristics collected from a network security appliance, router, or other device in a feature-rich environment, and transforming the first feature-rich data set into a second data set comprising feature-poor device characteristics with the known device identities. A third feature-poor data set is also collected from a device in a feature-poor network environment, such as from a user's computer or other network device in a feature-poor environment.

A statistical model is derived that reflects a difference in statistical distribution between one or more corresponding and/or related characteristics of the collected third feature-poor data set and the second data set of feature-poor device characteristics transformed from the first data set of feature-rich device characteristics, such that a feature-rich data set transformed and processed via the statistical model resembles the feature-poor data set.

A first, feature-poor device identification module is then trained based on the second data set of transformed feature-poor characteristics and the statistical model adjustments, and the trained first feature-poor device identification module is deployed to a feature-poor device such as a user's computer such that it can be used along with observed feature-poor device characteristics to identify network devices. In a further example, a second, feature-rich device identification module is trained based on the second data set of transformed feature-poor characteristics without the statistical model adjustments, and the trained second feature-rich device identification module is deployed to a feature-rich network environment device such as a router such that it can be used along with observed feature-rich device characteristics to identify network devices.

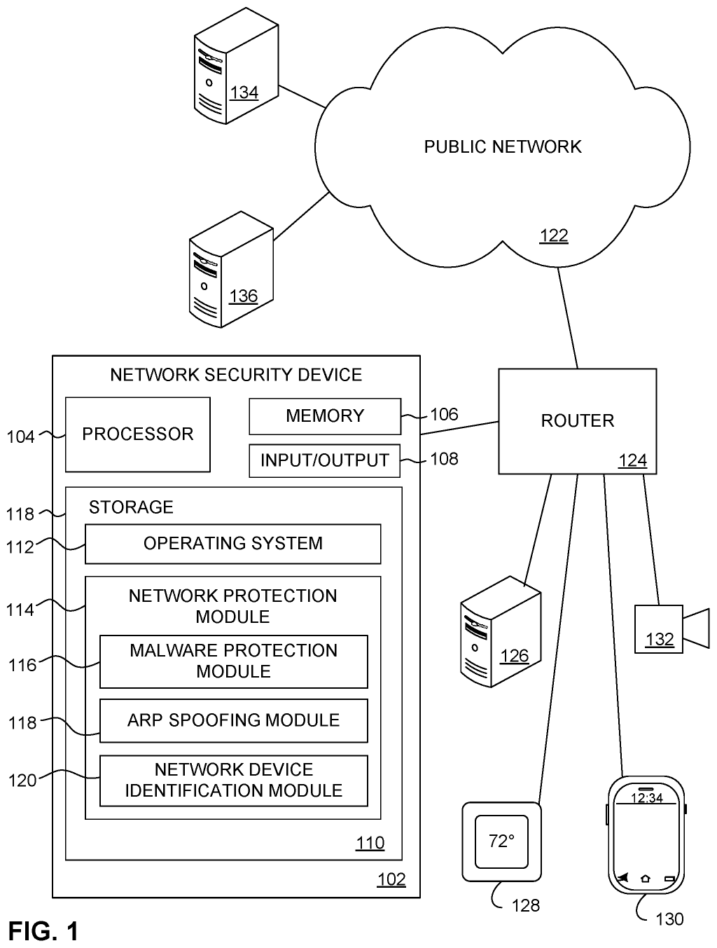

FIG. 1 shows a computerized network security device including a network device identification module, consistent with an example embodiment. Here, a network security device 102 comprises a processor 104, memory 106, input/output elements 108, and storage 110. Storage 110 includes an operating system 112, and network protection module 114 that is operable to provide various functions to protect devices on a private network from potentially harmful network content. The network protection module 114 further comprises a malware protection module 116 operable to search for and detect known or potentially malicious content in network communication, and ARP spoofing module operable to insert the network security device between a router and private network devices in a private network. This is achieved by notifying the router that it is to receive network traffic destined for the private network devices, and notifying network devices that it is to receive traffic destined for the router. This enables the network security device to inspect the network traffic between the router (and a public network such as the Internet) and private network devices and to selectively block content known or suspected to be malicious.

The network protection module 114 also includes a network device identification module 120, which can be used to identify various devices on the private network, such as to determine whether various devices have known vulnerabilities, compatibility issues, or other such characteristics. In one such example, the network security device 102 determines whether the router 124 is compatible with the network security device or requires special configuration to be used in an ARP spoofing environment.

The network security device 102 is coupled to a public network 122 via the router 124, which also couples the network security device to other local network devices including personal computer 126, smart thermostat 128, smart phone 130, and video camera 132. These devices may communicate with remote servers 134 via the public network 122, including potentially downloading malicious content from the servers. The public network devices may also be attacked by remote computers 136, such as by malicious users looking for known flaws in routers 124 or other such vulnerabilities to access the private network devices. In various examples, malicious users can attempt to steal information such as logins or financial account information, steal computing resources such as to use personal computer 126 to mine cryptocurrency or send spam emails as part of a botnet, or access private data such as snooping on the private network's environment by unauthorized access of video camera 132.

In operation, the network security device 102 is connected to a private network by establishing a network connection between the network security device and the local network's router 124. The network security device uses its network identification module to determine what devices are on the private network, such as what vulnerable devices such as security camera 132 are on the local network and what router 124 is managing the local network. The router 124 is configured via the network security device 102's ARP spoofing module 118 to intercept traffic between the router and private network devices, after which the network security device uses malware protection module 116 to selectively block known or potentially malicious content from public network 122 from reaching the local network devices.

The network identification module in a more detailed example identifies or classifies network devices by observing various device characteristics, which in this example are feature-rich in that the network security device 102 is able to observe network traffic to and from the local network devices and to directly query the devices for characteristics such as open ports, content available through various services such as a device administration web page served by an HTTP or HTTPS server on the device, and the like. Other devices such as computer 126 and smart phone 130 will have feature-poor information regarding network devices, as they are not able to observe all network traffic to and from other network devices and may have ports or other services blocked via the router 124, a firewall (including a firewall on a device such as 126-132), or other such mechanism. In a further example, features in the observed feature-poor device characteristics may overlap with, map to, or otherwise be related to features observed in the feature-rich data set, such that features or characteristics in one data set can be transformed to a data set in the other feature space.

In a more detailed example, the network security device's network device identification module 120 collects a feature-rich data set of device characteristics by monitoring and querying local network devices 126-132. The collected first data set of feature-rich device characteristics of devices are associated with their known device identities, such as where an expert has confirmed the identity of a device having a certain set of features or defined a set of rules used to positively identify a device. In one such example, a security camera's configuration web page served via HTTP on port 80 comprises a manufacturer and model name of the device, and in other examples other such device characteristics can be determined sufficient to positively identify a device.

The collected first data set of feature-rich device characteristics of devices and their associated known device identities are then transformed to a second data set comprising feature-poor device characteristics with the known device identities. This second set is received in a backend server in some examples, or a local server or computing device in other examples. Similarly, a third data set of feature-poor device characteristics is captured from one or more computing devices in a feature-poor environment such as an end user computer system, and is also forwarded to the backend server or other such device.

The second and third data sets are used to derive a statistical model comprising one or more adjustments to the second data set's transformed feature-poor data such that the statistical model reflects a difference in statistical distribution between one or more characteristics of the second data set of transformed feature-rich device characteristics and one or more corresponding and/or related characteristics of the third data set of feature-poor device characteristics.

This statistical model is employed by the backend server or other such device along with the second data set to train a first device identification model that is provided to devices operating in a feature-poor environment such as end user devices, while a second device identification model is trained using the second data set without the statistical model adjustments for use in identifying network devices in feature-rich environments such as network routers, gateways, and similar devices.

The trained first device identification module can then be implemented or deployed in a feature-poor environment such as the personal computer 126 or smart phone 130 to use observed feature-poor device characteristics to identify other network devices, such as in an antimalware application, device firewall, or the like. Similarly, the trained second device identification model is deployed to feature-rich network environments such as router 124 or network security appliance 102 to identify network devices, such as within the network security device 102's network identification module 120.

In a more detailed example, the second data set of transformed feature-poor characteristics are used to train the model such that the feature-rich data collected in the feature-rich deployed environment is similarly transformed to a feature-poor data model before being used in the network device identification module to identify a device.

Transforming the feature-rich data set to a feature-poor data set comprises in some embodiments mapping equivalent, related, or statistically correlated features in one set to one or more features in the other data set. Such mapping may be one-to-one, one-to-many, and/or many-to one in various examples. In another example, the feature-poor data set comprises at least partially a subset of the feature-rich data set or comprises condensed features of the feature-rich data set, such as mapping any HTTP, HTTPS, port 8080, and other HTTP traffic in a feature-rich data set to a single HTTP characteristic in the feature-poor data set. The feature-poor data set in some examples comprises in whole or in part a subset of the feature-rich data set. In other examples, other methods of producing a feature-poor data set that is approximately equivalent to the feature-rich data set will be employed.

The feature-rich data set in some examples is feature-rich due to availability of more network device characteristics, such as where a network security appliance can monitor network traffic going into and out of the device, probe open device ports, analyze responses from the device such as an HTTP configuration page, and the like. In contrast, feature poor-data sets are assembled from less data, such as a device's anti-malware software, which typically will not be able to monitor traffic on the local network and may have limited ability to probe other devices on the network. Other examples of characteristics that may be included in feature-rich and/or feature-poor data sets include network protocols, network services, open ports, traffic types, network traffic, and network packet content.

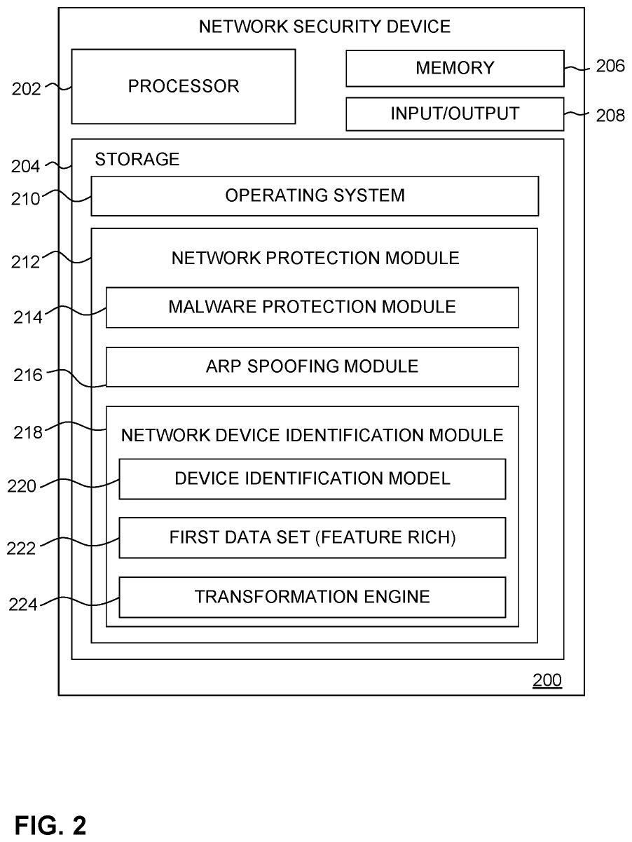

FIG. 2 shows a more detailed example of a network device employing a network device identification module, consistent with an example embodiment. Here, processor 202 is operable to execute program instructions loaded from storage 204 into memory 206. The program instructions use input/output 208, such as a network interface, to perform various functions such as communicating with other computerized devices coupled to the same network. Storage 204 also includes operating system 210, which controls the computerized device's basic functions and facilitates executable software programs' interaction with the computerized device's hardware and services.

The network security device 200 here includes a network protection module 212, which in various embodiments is an executable application, a service executing within the operating system, or some other combination of hardware and/or software. The network protection module 212 includes malware protection module 214, which is operable to screen data for known or suspected malicious content, and in a further example to block execution, network transmission, or other activity related to the known or suspected malicious content. ARP spoofing module 216 enables the network security device 200 to insert itself into a private network between a router or gateway and other private network devices by broadcasting ARP packets that falsely associate the network security device's MAC address with the IP addresses of other network devices, such that network traffic from router 124 to private network devices such as smartphone 130 is instead routed to the network security device 102, which screens the network traffic for known or suspected malicious content and selectively forwards the network traffic to smartphone 130. Similarly, traffic from private network devices such as smartphone 130 destined for the router is instead sent to the network security device 102, which inspects the traffic for content such as a web page request for a known or suspicious website, and selectively blocks or forwards such traffic to router 124.

Network device identification module 218 in this example provides various functions related to gathering and processing device identification data, as well as identifying devices using a model trained using the gathered device identification data. More specifically, device identification module 220 is in this example trained and provided by a remote server, and is employed to identify other devices on the same network as the network security device. First data set 222 is a feature-rich data set of network device characteristics of devices observed on the local network, captured and sent to a backend or remote server. Transformation engine 224 transforms the first data set collected in the feature-rich environment of the network security device to a data set in a feature-poor data space. The transformation engine is in this example is embodied within the network device identification module 218 of the network security device, but in other examples is embodied elsewhere such as in the backend server. In some examples, the first data set 222 and transformation engine 224 are not required, as the device identification module 220 received from the backend server is derived using data sets collected from other devices.

In a more detailed example, the first data set comprises an observed data set that is feature-rich, and transformation engine 224 generates a second data set that has reduced features that in some examples are the same or similar to the features of the feature-rich data set. In other examples, the transformed data set comprises feature-poor data set with its own set of features, such as features selected for their value in training a device identification model 220. A device identification model 220 is in this example constructed using the second transformed data set without statistical adjustments for use in the feature-rich environment of the network security device 200, but in other examples will be constructed using differences between the second transformed data set and a third, feature poor data set for use in a feature-poor environment such as an end user's computer.

For models deployed to a feature-rich data environment such as a network security device, the device identification model 220 is trained on a transformed second data set derived from a first unweighted feature-rich data set. For models deployed to a feature-poor environment, such as an end user device's internal antimalware software, a more complex model is generated. First, the second feature-poor transformed data set collected from a feature-rich environment is compared with the third feature-poor data set collected from a feature-poor environment, and key distinguishing factors are identified. Evaluation metrics or weights are derived to account for the distinguishing factors, such as the difference in weight of a similar feature in the second transformed data set and third feature-poor data sets. These weights or statistical adjustments are then applied to the transformed second data set derived by transformation engine 224 to produce a feature-poor environment device identification model, such as by training a machine learning model using the transformed feature data set and the weights that account for a difference in statistical relevance between similar factors in the second transformed data set and third feature-poor data sets. The trained feature-poor environment device identification model is therefore different from the trained feature-rich device identification model in that it is trained with weighted transformed feature data, improving its performance in an environment with a different feature set available with which to identify network devices.

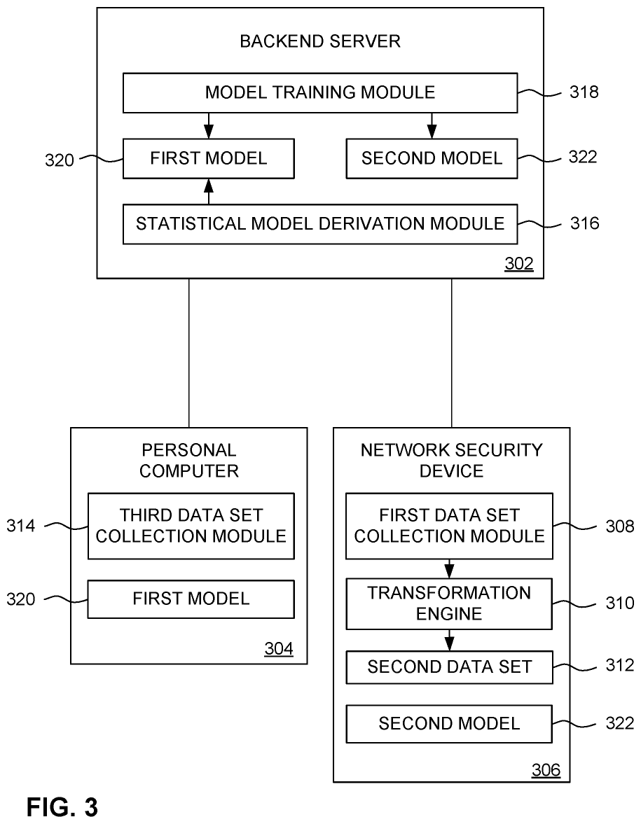

FIG. 3 is a block diagram of a network device identification system, consistent with an example embodiment. Here, a backend server 302 is connected to a personal computer 304 in a feature-poor environment, and a network security device 306 in a feature-rich environment. The network security device collects feature-rich data in a first data set collection module 308, and transforms the data using transformation engine 310 to a second data set of feature-poor data 312. The personal computer 304 similarly collects a third feature-poor data set using third data set collection module 314, and the second data set 312 and third data set from 314 are sent to the backend server 302.

The backend server 302 employs a statistical model derivation module 316 to evaluate differences between the second and third data set, and model training module 318 to train two different models. More specifically, first model 320 for use in a feature-poor network environment such as personal computer 304 is generated using the second data set 312 and statistical adjustments between the second data set 312 and third data set collected at 314 derived from statistical model derivation module 316. Second model 322, for use in a feature-rich environment such as the network security device 306, is generated using model training module 318 and second data set 312 without statistical adjustments from statistical model deviation module 316. The first model 320 is then deployed to feature-poor environments such as a personal computer 304, and the second model 322 is deployed to feature-rich environments such as network security device 306.

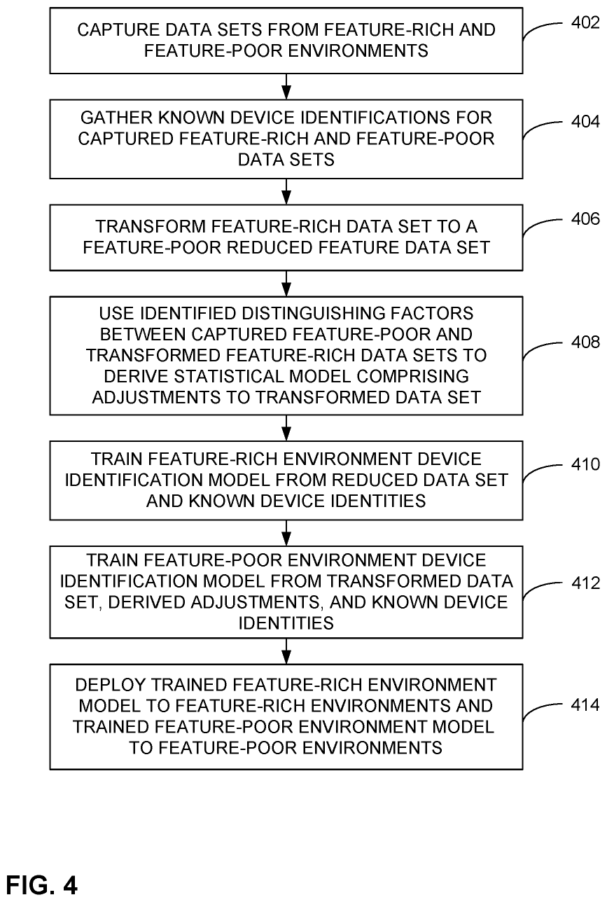

FIG. 4 is a flowchart of a method of identifying a network device, consistent with an example embodiment. At 402, the network device identification module of a network security appliance or other computerized device begins the process of generating device identification models to be deployed by capturing data sets from feature-rich and feature-poor environments, such as a network security appliance for the feature-rich data set and a device's internal antimalware software for the feature-poor data set. The captured data is paired with known device identifications at 404, such as by using an expert or expert-derived rules or classifications to determine or confirm the known identity of devices in the feature-poor and feature-rich data sets. The first captured feature-rich data set is transformed to a feature-poor data set, or a second transformed data set, at 406.

At 408, distinguishing characteristics between the transformed second data set and a third feature-poor data set captured in a feature-poor network environment are identified, and weights or metrics are determined using a statistical model as adjustments that can be applied to the second transformed data set set so that it produces statistically better results in a feature-poor data environment. A feature-rich environment device identification model is trained at 410, using the second transformed data set and known device identities. A feature-poor device identification model is similarly trained at 412, but uses the derived adjustments or weights in addition to the transformed feature-poor data set and known device identities. The models can then be deployed to their respective environments at 414—the feature-poor device identification model to a feature-poor environment such as a device's internal antimalware software, and the feature-rich device identification model to a feature-rich environment such as a network security device, router, or the like.

The examples presented here show how network devices can be identified and/or classified by training a feature-poor transformed feature training set, using adjustments or weights to train a model deployed to a feature-rich environment. The same transformed feature set can also be used to train a model deployed to a feature-poor environment, without the adjustments or weights. Such a system provides for training models for both feature-rich and feature-poor environments from the same transformed feature-poor data set and known or confirmed device identities, reducing the workload on developers in generating models for different platforms as new devices are developed and found in local network environments.

Although network device identification modules shown in the examples here are implemented on a computer or a network security device, a variety of other computerized systems may be used in other examples for the network device identification module, as well as various clients, servers, and other devices involved in performing the methods described in the examples above.

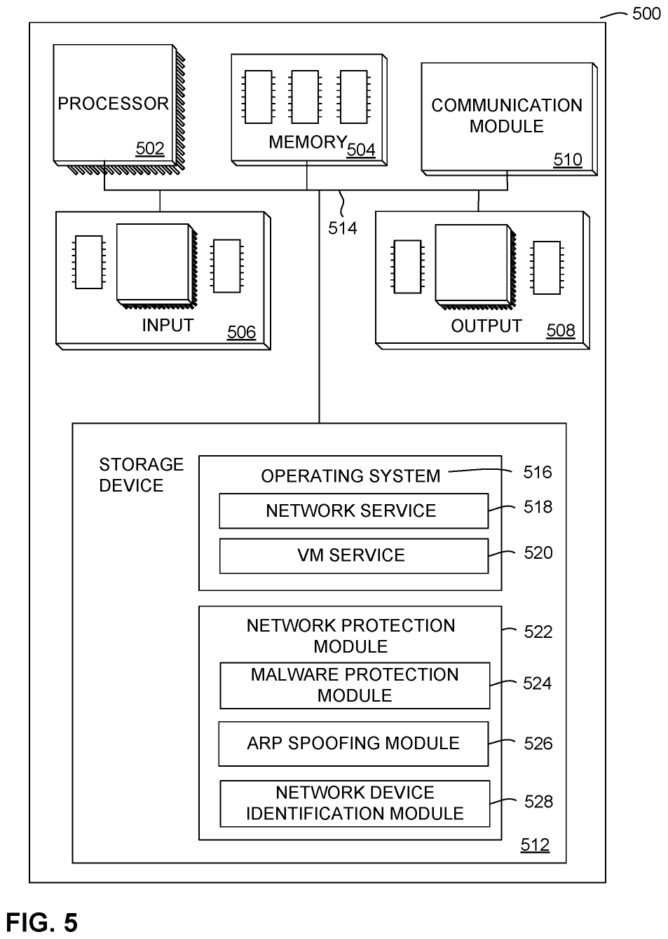

FIG. 5 is a computerized system comprising a network device identification module, consistent with an example embodiment. FIG. 5 illustrates only one particular example of computing device 500, and other computing devices 500 may be used in other embodiments. Although computing device 500 is shown as a standalone computing device, computing device 500 may be any component or system that includes one or more processors or another suitable computing environment for executing software instructions in other examples, and need not include all of the elements shown here.

As shown in the specific example of FIG. 5, computing device 500 includes one or more processors 502, memory 504, one or more input devices 506, one or more output devices 508, one or more communication modules 510, and one or more storage devices 512. Computing device 500, in one example, further includes an operating system 516 executable by computing device 500. The operating system includes in various examples services such as a network service 518 and a virtual machine service 520 such as a virtual server. One or more applications, such as network protection module 522 are also stored on storage device 512, and are executable by computing device 500.

Each of components 502, 504, 506, 508, 510, and 512 may be interconnected (physically, communicatively, and/or operatively) for inter-component communications, such as via one or more communications channels 514. In some examples, communication channels4 include a system bus, network connection, inter-processor communication network, or any other channel for communicating data. Applications such as network protection module 522 and operating system 516 may also communicate information with one another as well as with other components in computing device 500.

Processors 502, in one example, are configured to implement functionality and/or process instructions for execution within computing device 500. For example, processors 502 may be capable of processing instructions stored in storage device 512 or memory 504. Examples of processors 502 include any one or more of a microprocessor, a controller, a digital signal processor (DSP), an application specific integrated circuit (ASIC), a field-programmable gate array (FPGA), or similar discrete or integrated logic circuitry.

One or more storage devices 512 may be configured to store information within computing device 500 during operation. Storage device 512, in some examples, is known as a machine-readable storage medium. In some examples, storage device 512 comprises temporary memory, meaning that a primary purpose of storage device 512 is not long-term storage. Storage device 512 in some examples is a volatile memory, meaning that storage device 512 does not maintain stored contents when computing device 500 is turned off. In other examples, data is loaded from storage device 512 into memory 504 during operation. Examples of volatile memories include random access memories (RAM), dynamic random access memories (DRAM), static random access memories (SRAM), and other forms of volatile memories known in the art. In some examples, storage device 512 is used to store program instructions for execution by processors 502. Storage device 512 and memory 504, in various examples, are used by software or applications running on computing device 500 such as network protection module 522 to temporarily store information during program execution.

Storage device 512, in some examples, includes one or more computer-readable storage media that may be configured to store larger amounts of information than volatile memory. Storage device 512 may further be configured for long-term storage of information. In some examples, storage devices 512 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 500, in some examples, also includes one or more communication modules 510. Computing device 500 in one example uses communication module 510 to communicate with external devices via one or more networks, such as one or more wireless networks. Communication module 510 may be a network interface card, such as an Ethernet card, an optical transceiver, a radio frequency transceiver, or any other type of device that can send and/or receive information. Other examples of such network interfaces include Bluetooth, 4G , LTE, or 5G, WiFi radios, and Near-Field Communications (NFC), and Universal Serial Bus (USB). In some examples, computing device 500 uses communication module 510 to wirelessly communicate with an external device such as via public network 122 of FIG. 1.

Computing device 500 also includes in one example one or more input devices 1006. Input device 506, in some examples, is configured to receive input from a user through tactile, audio, or video input. Examples of input device 506 include a touchscreen display, a mouse, a keyboard, a voice responsive system, video camera, microphone or any other type of device for detecting input from a user.

One or more output devices 508 may also be included in computing device 500. Output device 508, in some examples, is configured to provide output to a user using tactile, audio, or video stimuli. Output device 508, in one example, includes a display, a sound card, a video graphics adapter card, or any other type of device for converting a signal into an appropriate form understandable to humans or machines. Additional examples of output device 508 include a speaker, a light-emitting diode (LED) display, a liquid crystal display (LCD), or any other type of device that can generate output to a user.

Computing device 500 may include operating system 516. Operating system 516, in some examples, controls the operation of components of computing device 500, and provides an interface from various applications such as network protection module 522 to components of computing device 500. For example, operating system 516, in one example, facilitates the communication of various applications such as network protection module 522 with processors 502, communication unit 510, storage device 512, input device 506, and output device 508. Applications such as network protection module 522 may include program instructions and/or data that are executable by computing device 500. As one example, network protection module 522 executes a malware protection module 424 that protects local network devices by selectively filtering network traffic after ARP spoofing module 526 has inserted itself between the local network devices and the router in the local network. A network device identification module 528 queries private network devices such as the router for information such as web pages hosted by the device's HTTP server, open ports, or monitored network traffic content to identify the device. Network device identification module 528 in a further example provides device identity information to malware protection module 524 for use in protecting the network, such as to identify a video camera 132 that has known security flaws or a router 124 that is incompatible with or requires special configuration to work with ARP spoofing module 526.

Network device identification module 528 in a further example is operable to gather feature-rich network device data and/or to use such observed feature-rich network device data to generate a transformed feature-poor or reduced feature training set. The transformed set is used with known device identities and adjustments or weights to train a device identification module 528 that can be deployed to a feature-rich environment. The same transformed feature set can also be used to train a model deployed to a feature-poor environment, without the adjustments or weights. In other examples, some or all of the functions described are performed by other computers, such as using a remote server to create the reduced feature training set, generate weights, and train the model that is then deployed back to network device identification module 528. Training models for both feature-rich and feature-poor environments from the same reduced feature-poor data set and known or confirmed device identities reduces the workload on developers in generating models for different platforms as new devices are developed and found in local network environments. These and other program instructions or modules may include instructions that cause computing device 500 to perform one or more of the other operations and actions described in the examples presented herein.

Although specific embodiments have been illustrated and described herein, any arrangement that achieve the same purpose, structure, or function may be substituted for the specific embodiments shown. This application is intended to cover any adaptations or variations of the example embodiments of the invention described herein. These and other embodiments are within the scope of the following claims and their equivalents.

1. A method of identifying network devices, comprising:
transforming a first data set of feature-rich device characteristics of devices with known device identities to a second data set of transformed device characteristics comprising feature-poor device characteristics with the known device identities;
collecting a third data set of feature-poor device characteristics of devices with known identities;
deriving a statistical model comprising one or more adjustments to the transformed data set, the statistical model reflecting a difference in statistical distribution between one or more characteristics of the second data set of transformed device characteristics and one or more corresponding and/or related characteristics of the third data set of feature-poor device characteristics; and
training a device identification model based on the second data set of transformed device characteristics and the statistical model adjustments, the trained device identification module operable to use feature-poor device characteristics to identify network devices.

2. The method of identifying network devices of claim 1, further comprising deploying the trained device identification model to a feature-poor environment

3. The method of identifying network devices of claim 2, wherein the feature-rich environment comprises an end user computing device.

4. The method of identifying network devices of claim 1, further comprising training a second device identification model based on the second data set of feature-poor characteristics without the statistical model adjustments, the trained second device identification module operable to use feature-poor device characteristics to identify network devices.

5. The method of identifying network devices of claim 4, further comprising deploying the trained second device identification model to a feature-rich environment

6. The method of identifying network devices of claim 5, wherein the feature-rich environment comprises a router, a gateway, or a network security device.

7. The method of identifying network devices of claim 1, further comprising collecting the first data set of feature-rich device characteristics from at least one router, gateway, or network security device.

8. The method of identifying network devices of claim 1, wherein the devices with known identities comprise devices that have been classified by an expert or have been classified by expert-derived rules or classifications.

9. The method of identifying network devices of claim 1, wherein transforming the first data set of feature-rich device characteristics to the second data set of transformed device characteristics comprises reducing the feature-rich data set to produce a feature-poor data set approximately equivalent to the feature-rich data set.

10. The method of identifying network devices of claim 1, wherein the first data set of feature-rich device characteristics comprises a data set associated with at least one network security appliance, and the third data set comprising feature-poor device characteristics comprises a data set associated with a device antimalware application.

11. The method of identifying network devices of claim 1, wherein at least one of the feature-rich or feature-poor characteristics comprise network protocols, network services, open ports, traffic types, network traffic, and network packet content.

12. The method of identifying network devices of claim 1, wherein the feature-poor characteristics comprise at least partially a subset of the feature-rich characteristics.

13. A computerized network device, comprising:
a processor and a memory,
a nonvolatile storage operable to store program instructions executable on the processor when loaded into memory; and
machine-readable instructions stored on the nonvolatile memory, operable when executed to cause the computerized system to:
transform a first data set of feature-rich device characteristics of devices with known device identities to a second data set of transformed device characteristics comprising feature-poor device characteristics with the known device identities;
collect a third data set of feature-poor device characteristics of devices with known identities;
derive a statistical model comprising one or more adjustments to the transformed data set, the statistical model reflecting a difference in statistical distribution between one or more characteristics of the second data set of transformed device characteristics and one or more corresponding and/or related characteristics of the third data set of feature-poor device characteristics; and
train a device identification model based on the second data set of transformed device characteristics and the statistical model adjustments, the trained device identification module operable to use feature-poor device characteristics to identify network devices.

14. The computerized network device of claim 13, the machine-readable instructions when executed further operable to identify one or more network devices using the trained device identification model.

15. The computerized network device of claim 13, the machine-readable instructions further operable when executed to train a second device identification model based on the second data set of feature-poor characteristics without the statistical model adjustments, the trained second device identification module operable to use feature-poor device characteristics to identify network devices.

16. The computerized network device of claim 15, the machine-readable instructions when executed further operable to identify one or more network devices using the trained second device identification model in a feature-rich environment.

17. The computerized network device of claim 13, the machine-readable instructions when executed further operable to collect the first data set of feature-rich device characteristics.

18. The computerized network device of claim 13, wherein transforming the first data set of feature-rich device characteristics to the second data set comprising feature-poor device characteristics comprises reducing the feature-rich data set to produce a feature-poor data set approximately equivalent to the feature-rich data set.

19. The computerized network device of claim 13, wherein the first data set of feature-rich device characteristics comprises a data set associated with at least one router, gateway, or network security appliance, and the second data set comprising feature-poor device characteristics comprises a data set associated with a device antimalware application.

20. The computerized network device of claim 13, wherein at least one of the feature-rich or feature-poor characteristics comprise network protocols, network services, open ports, traffic types, network traffic, and network packet content.
